(19) United States
(12) Patent Application Publication
(10) Pub. No.: US 2008/0247065 A1
(43) Pub. Date: Oct. 9, 2008

(54) METHOD OF MAKING STRUCTURED OPTICAL FILMS

(75) Inventors: Gary T. Boyd, Woodbury, MN (US); Robert M. Emmons, St. Paul, MN (US); Leland R. Whitney, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/697,553

(22) Filed: Apr. 6, 2007

(51) Int. Cl. G02B 7/18

(52) U.S. Cl. 359/831; 65/181; 65/60.1

(57) ABSTRACT

Methods for fabricating an optical film characterizable by a relationship between gain and thickness to prism pitch ratio (S/p) that varies cyclically are described. The thickness and the prism pitch of the optical film are selected based on the relationship between gain and S/p ratio, to obtain a desired gain. The optical film is formed having the S/p ratio that provides the desired gain.

### TECHNICAL FIELD

The present invention is related to optical films, methods for making optical films, and systems incorporating optical films.

### BACKGROUND

Flat panel displays are used in a variety of applications ranging from relatively large devices including computer monitors and televisions, to small, handheld devices such as cell phones, portable DVD players, wristwatches, and gaming devices. Many flat panel displays use optically active materials, such as liquid crystals, and a light source for backlighting the optically active materials. Films disposed between the liquid crystals and a backlight have been used to enhance the brightness of the displays. For example, brightness enhancement films may be used to increase the light exiting in a direction normal, or “on-axis,” to the surface of the display. Increasing the amount of on-axis light reduces the amount of energy required to generate a desired amount of on-axis luminance. This is particularly important for optical displays that use battery powered light sources.

In general, the increase in on-axis brightness produced by such a brightness enhancement film is known as the “gain” of such a film. The on-axis gain of a film refers to the ratio of the intensity of light as measured in a direction perpendicular to the surface of the display to the intensity of light measured in a direction perpendicular to the surface without the film.

Brightness enhancing films having one substantially flat surface and another surface having prismatic structures are frequently used to direct light that would otherwise not be viewed along the viewing axis. A typical flat panel display device may use several different films to provide an overall bright, high contrast display with substantially uniform output along the preferred viewing directions.

There is a need for enhanced optical films and methods for making optical films to enhance brightness of displays without increasing system power requirements. The present invention fulfills these and other needs, and offers other advantages over the prior art.

### SUMMARY

The present invention is related to optical films, methods for making optical films, and systems incorporating optical films. One embodiment of the invention involves a method of fabricating an optical film having a non-prism portion with a thickness, S, and prisms arranged with a pitch, p, the optical film characterizable by a relationship between gain and thickness to prism pitch ratio (S/p) that varies cyclically. The method includes selecting, based on the relationship between gain and S/p ratio, one or both of the thickness, S, and the prism pitch, p, of the optical film to obtain an S/p ratio that provides a desired gain. The optical film is formed having the S/p ratio that provides the desired gain.

According to one aspect of this method, the thickness and prism pitch ratio are selected to obtain an S/p ratio that provides a desired gain within a predetermined range of a peak gain for a cycle of the gain to S/p relationship of the optical film. In one implementation, the desired gain may fall within a range of at least about 90% of a peak value of a gain of the optical film for a cycle of the gain to S/p relationship of the optical film. The cycle of the gain to S/p relationship used for selection of the thickness and prism pitch may be the first cycle or may be any other cycle of the gain to S/p relationship.

The prisms may have an included angle of about 90°, between about 70° to about 120°, or other included angle. In various configurations, the trough or peak radius of the prisms may be in a range of about 0.1 μm to about 10 μm, and/or the index of refraction of the non-prism and/or prism portions may be about 1.5 to about 1.7, for example.

Two or more of the optical films described herein may be used together, or the optical film described herein may be disposed on an additional optical layer such as a reflective polarizer. For example, two optical films may be arranged so that the prism axes of the films are at an angle to one another. In some implementations, the angle between the prism axes of the optical films may range from about 45° to about 135°. In one arrangement, the angle between the prism axes is 90°.

Another embodiment of the invention involves an optical film characterizable by a relationship between gain and thickness to prism pitch ratio (S/p) that varies cyclically. The optical film includes a non-prism portion having a thickness, S; and prisms arranged with a prism pitch, p. Parameters of the film may be varied to achieve a desired configuration. In various configurations, the S/p ratio of the optical film may be selected to fall within a range that provides some percentage, such as about 90%, of the peak gain for a cycle of the gain to S/p relationship. For example, in one configuration, a cycle other than the first cycle of the gain to S/p relationship may be used and thickness and prism pitch may be selected to provide some percentage of the peak gain for the cycle other than the first cycle.

In another configuration, the thickness and prism pitch may be selected to produce a desired gain for an optical film having a non-prism portion with an index of refraction less than 1.587, between 1.587 and 1.665 or greater than 1.665. In yet another configuration, the trough and/or peak radius of the prisms may be greater than about 1 μm. In a further configuration, the prisms may have an included angle other than 90°.

Another embodiment of the invention is directed to an optical film characterizable by a relationship between gain and thickness to prism pitch ratio (S/p) that varies cyclically. The optical film includes a non-prism portion having a thickness, S and prisms arranged with a prism pitch, p. The S/p ratio of the optical film is within a range that provides at least about 90% of a peak gain for a cycle of the S/p relationship of the optical film, excluding an optical film having a thickness of 2 mils (±1%), a prism pitch of 18 um (±1%), an included angle of 90° (±2 degrees), an index of refraction of 1.587 (±0.2%), and a trough width of 1 um (±0.2%) and an optical film having a thickness of 5 mils (±1%), a prism pitch of 50 um (±1%), an included angle of 90° (±2 degrees), a trough or peak radius of 1 um (±0.2%) and an index of refraction of 1.665 (±0.2%).

The optical film described herein may provide the optimal gain in a direction substantially normal to a plane of the optical film and/or in a range of about +20° to about −20° from a direction normal to a plane of the optical film, for example. The prisms may be right regular prisms and/or may have an included angle in a range of about 70° to about 120°.

The optical films may be used with one or more additional optical layers such as a reflective polarizer or may be used with another optical film of a similar construction. The prism axes of the two or more optical layers or films may be disposed at an angle, such as 90° or between about 45° and 135° or other angle.

The optical films described herein may be used in various applications and are particularly useful for displays, laptop or desktop computer monitors, cellular telephones, televisions, MP3 players, gaming devices and various other display applications.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### DESCRIPTION OF THE DRAWINGS

FIGS. 1A and 1B illustrate structured brightness enhancement films in accordance with embodiments of the invention;

FIG. 2 shows a representative graph for a typical optical film illustrating the cyclical relationship between gain and film thickness to prism pitch ratio with is used to achieve a desired gain for an optical film in accordance with the embodiments of the invention;

FIG. 3 provides superimposed graphs of the Gain vs. S/p relationships for films having prisms with included angles ranging from 80° to 100°;

FIG. 4 shows superimposed graphs of Gain vs. S/p for films with varying trough radii that illustrate the effect of trough radius on the Gain vs. S/p relationship.

FIGS. 5A-5D provide ray trace histories illustrating the effect of varying film thickness and index of refraction on the operation of brightness enhancement films;

FIG. 6 is a flow diagram that illustrates a method for forming an optical film in accordance with embodiments of the invention;

FIG. 7 is a graph illustrating selection of S/p ratios that provide 90%, or other predetermined percentage, of the peak gain for cycles m=1 or 2 in accordance with embodiments of the invention;

FIG. 8 shows an optical assembly including two optical films arranged with their prisms axes pointing in different directions in the film plane to increase the on-axis gain of the overall structure in accordance with embodiments of the invention;

FIG. 9 illustrates a display panel incorporating one or more optical films in accordance with embodiments of the invention;

FIG. 10 shows basic components of a tablet, laptop, or desktop computer having a monitor that incorporates one or more optical films in accordance with embodiments of the invention;

FIG. 11 illustrates a block diagram of a television using one or more optical films as described in accordance with various embodiments of the invention;

FIG. 12 is a block diagram of a handheld MP3 player that includes a display using one or more optical films fabricated in accordance with embodiments of the invention; and

FIG. 13 provides a block diagram of a cellular telephone incorporating a display having one or more optical films in accordance with embodiments of the invention.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

Embodiments of the invention are based on recognition of the relationship between gain and film thickness to prism pitch (S/p) ratio for structured optical films. As ray tracing programs become more sophisticated, the ability to accurately model optical systems by forward and reverse ray tracing has been enhanced. Through the use of reverse ray tracing analysis, a previously unknown relationship between gain and the S/p ratio of optical films has been discovered. Various embodiments of the invention exploit this newly discovered relationship, facilitating the design and fabrication of brightness enhancement films that provide consistently higher on-axis gain than that of previous films.

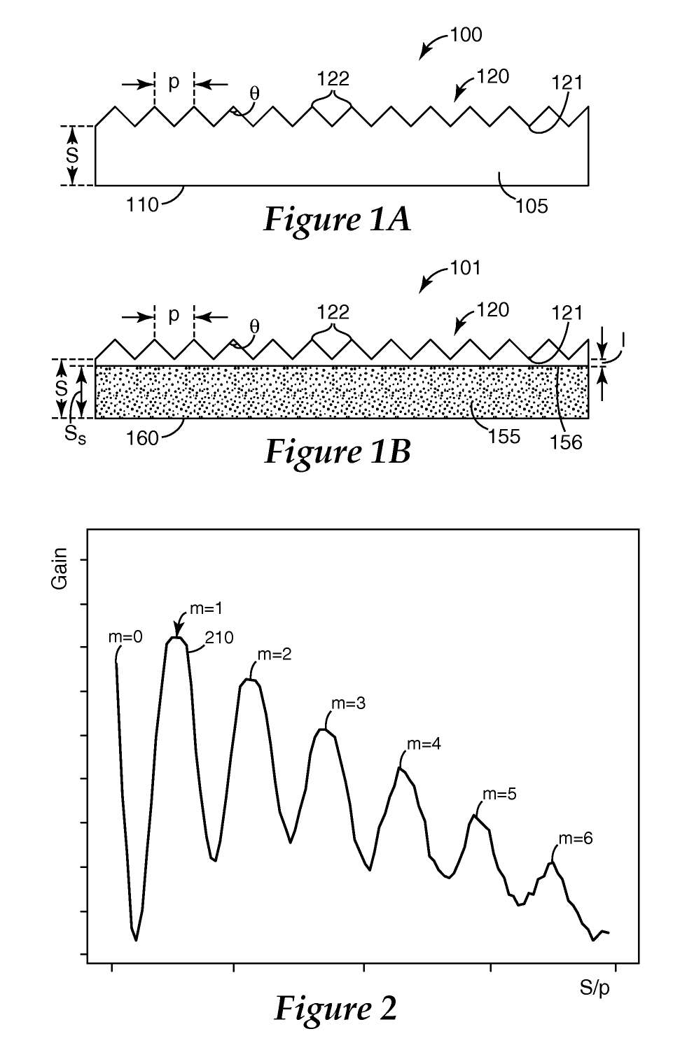

FIGS. 1A and 1B illustrate structured brightness enhancement films 100, 101. These drawings are not to scale. In particular, the size of the prisms 120 in FIGS. 1A and 1B are greatly exaggerated to facilitate an understanding of the films 100, 101.

The film 100 of FIG. 1A is a monolithic film having a substantially flat surface 105 and triangular prisms 120 on opposing sides of the film 100. The film 101 of FIG. 1B includes prisms 120 disposed on a substrate 155. The material used to form the prisms 120 may be the same or different from the substrate material. The substrate surface 160 opposing the prisms 120 is substantially flat.

Optical films according to the invention could be of any substantially transparent material. The films may be manufactured from suitable polymeric, acrylic, polycarbonate, UV-cured acrylate, or like materials, for example. A bulk diffusing material could be incorporated in a film according to the invention, although in many cases this will degrade the performance of the optical film. Unitary, extruded films of acrylics and polycarbonates work well. Alternatively, the film may be a two part construction, in which the structured surface according to the invention is cast and cured on a substrate. For example, ultraviolet-cured acrylics cast on polyester substrates may be used. Films of polyethylene terphthalate (“PET”) have been shown to work well as substrates on which structures of the invention may be cured. Biaxially oriented PET is often preferred for its mechanical and optical properties. A smooth polyester film that may be used as a substrate is commercially available from ICI Americas Inc. Hopewell, Va. under the tradename MELINEX 617. A matte finish coating that may be applied on a film to be used as a substrate is commercially available from Tekra Corporation of New Berlin, Wis. under the tradename MARNOT. 75 GU. The use of a matte finish coating may effect the brightness enhancement achievable using the techniques described herein, however, the matte finish may be otherwise desirable for certain applications.

The films 100, 101 of FIGS. 1A and 1B are characterized by a thickness S and a prism pitch p. The thickness, S, is measured from the flat surface of the film 110, 160 to the lowest point 121 of the prisms 120 and may range from 10 micrometers to 500 micrometers. The prism pitch, p, may be measured as the distance between prism peaks 122 or other periodically occurring features. For example, the prism pitch may vary between 5 micrometers to 200 micrometers. As illustrated in FIG. 1B, the area between the top of the substrate 156 and the lowest point of the prisms 121 is the prism land, and the thickness of the land is designated as l. In FIG. 1B, the thickness of the film, S, includes the substrate thickness Sₛ added to the land thickness, l. The prisms 120 are also characterized by their included angle, θ, and prism peak and trough radii. In various configurations, the included angle of the prisms may range from about 70° to about 110°. In some configurations, the included angle of the prisms is about 90°. A prism peak and/or trough radius of between about 0.1 μm to about 20 μm may be used, for example.

In operation, light that is incident on the substantially flat surface 110, 160 of the film at relatively high incidence angles is refracted by the flat surface 110, 160, and the prisms 120 and is redirected so that is becomes substantially perpendicular, e.g., ±20°, to the flat surface 110, 160. Light incident on the prisms 120 at angles greater than a critical angle are reflected and redirected back through the flat surface 110, 160. This light is recycled by reflective surfaces below the flat surface 110, 160. The combination of refraction and reflection increases the amount of on-axis light and decreases the amount of off-axis light. The index of refraction of the film, measured at 589 nm, is typically greater than about 1.5 and for various films may fall within a range of about 1.55 to 1.57 or a range of about 1.64 to about 1.67, or other range, for example.

For a two-part construction, such as the film illustrated in FIG. 1B, the index of refraction of the prism portion may differ from the index of refraction of the substrate. However, this difference in the index is not critically important for the purposes of the discussion herein, and the index of the two-part film may be considered to be the index of the substrate.

Ray-tracing analyses using forward and reverse ray tracing were performed for structures similar to the ones described in connection with FIGS. 1A and 1B. These analyses reveal the cyclical relationship between on-axis gain of the optical film and S/p ratio.

FIG. 2 shows a representative graph 210 of gain vs. S/p for a typical optical film. As can be observed in graph of FIG. 2 as S/p increases, the on-axis gain goes through a number cycles designated in FIG. 2 as m=0, 1, 2, 3, 4, 5, 6. Each cycle is associated with a local peak gain. For the representative film corresponding to graph 210 of FIG. 2, the local peak gain for cycle m=1 represents the peak gain, Gₚ, for the film, which occurs at S/pₚ.

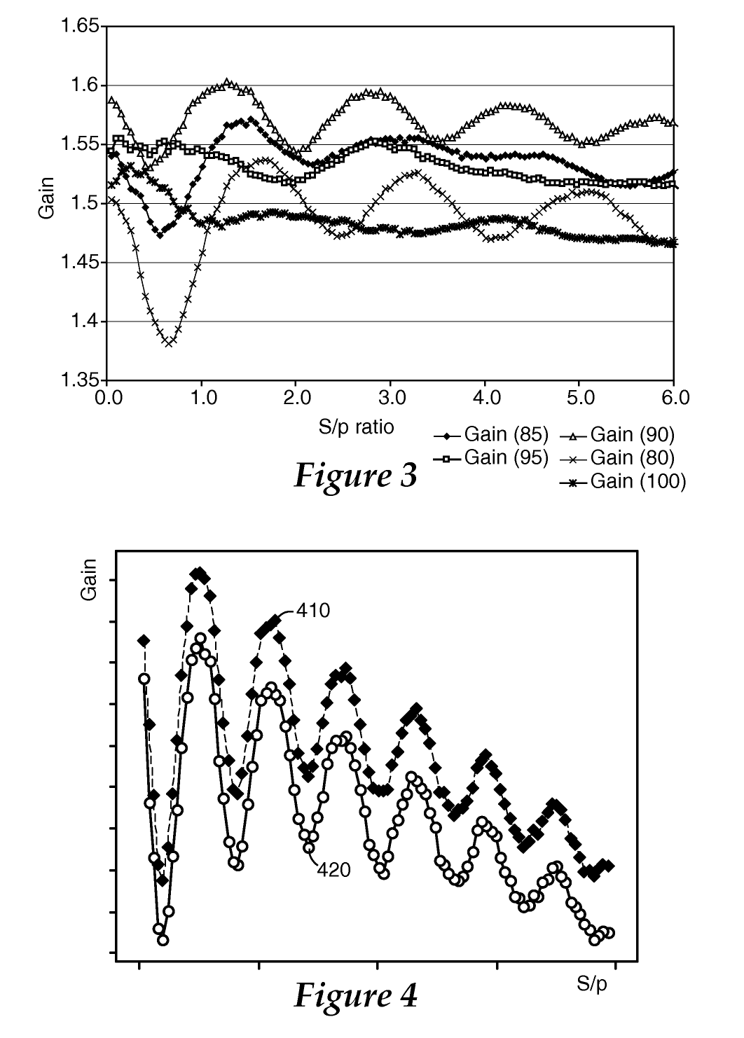

The cyclical variation of the Gain vs. S/p relationship is maintained even when other film parameters, such as index of refraction, prism included angle, and peak or trough radius, are varied. FIGS. 3 and 4 illustrate Gain vs. S/p graphs generated by computer modeling. FIG. 3 illustrates the Gain vs. S/p relationship with superimposed graphs corresponding to prism included angles ranging from 80° to 100°. For each included angle, the Gain vs. S/p graph shows cyclically occurring local peaks and valleys which are generally more pronounced at included angles nearer 90°.

FIG. 4 shows superimposed graphs of Gain vs. S/p for films with varying trough radii that illustrate the effect of trough radius on the Gain vs. S/p relationship. Gain vs. S/p was plotted for a film having smaller prism trough radius 410 (trough radius=0.5 μm) and for a film having a larger prism trough radius 420 (trough radius=1.0 μm). These graphs indicate an overall increase in gain for all cycles of Gain vs. S/p as trough radius is decreased.

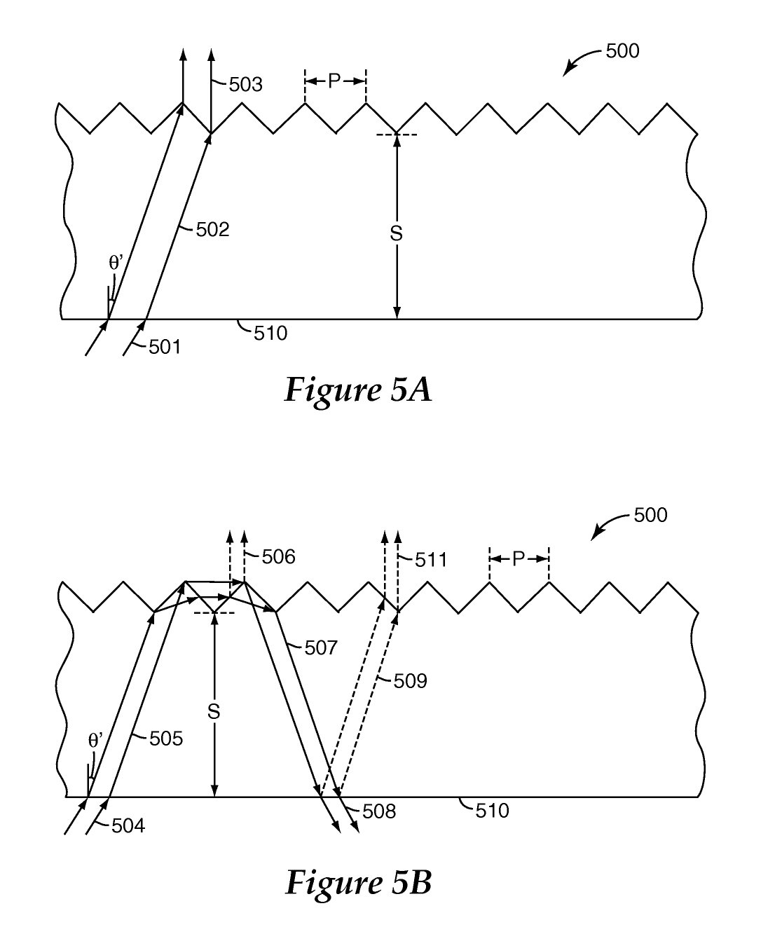

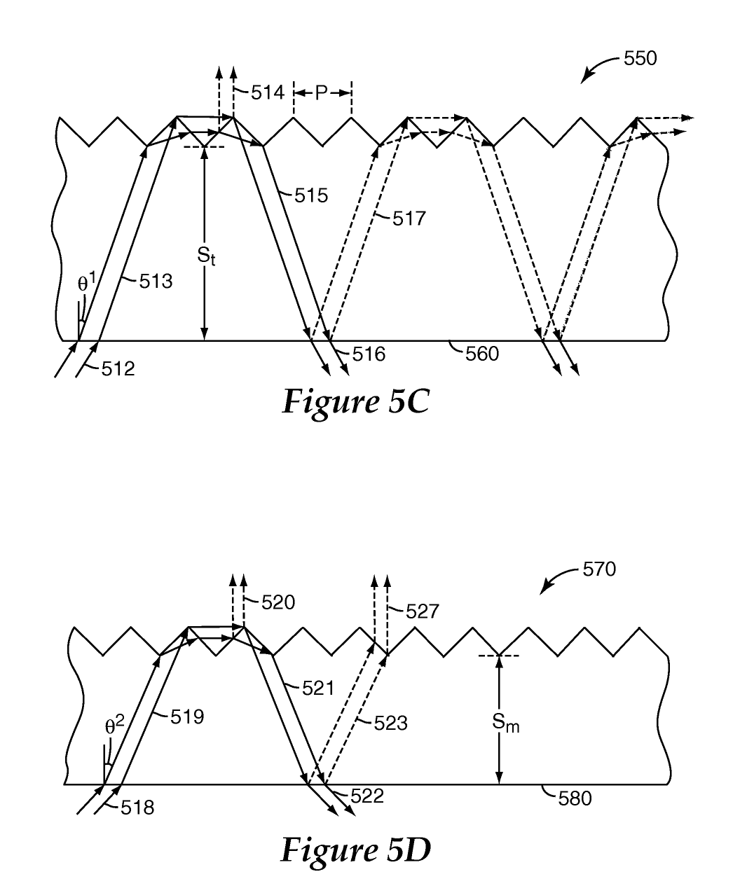

An optical film in accordance with embodiments of the invention having prisms pointing away from a light source can be used to concentrate light toward the normal direction to the plane of the film. Operation of films constructed according to the approaches described herein is illustrated with reference to FIGS. 5A-5D.

As illustrated in FIG. 5A, some fraction of incoming rays 501 entering at the flat surface 510 of an optical film having a thickness S and prism pitch p are refracted at the air-film interface 510 with internal refraction angle, θ₁, toward a prism. These refracted rays 502 strike the right facet of a prism exit the film 500 near on-axis with the viewing angle perpendicular to the plane of the film. The rays 503 are the main contributors to the on-axis light emitted from the optical film.

FIG. 5B shows a ray history in which rays 504 enter the film 500 and are refracted at the air-film interface 510 with internal refraction angle, θ₁, toward a prism. The refracted rays 505 strike the left facet of the prism and are reflected to the right facet of an adjacent prism. A portion of these rays strike the right facet and the rays 506 exit the film on-axis with the viewing angle. Another portion of the rays are reflected 507 toward the air-film interface 510. At the air-film interface 510, a portion of the rays 508 exit the film 500 and are recycled. Another portion of the rays 509 are reflected toward a prism, this time striking a right prism facet where the rays 511 exit the film 500, contributing to the on-axis light and the peak gain values.

FIG. 5C provides a ray history when the prism pitch remains constant but the film thickness is increased. Film 550 of FIG. 5C has prism pitch, p, and thickness, Sₜ. Incoming rays 512 are refracted at the air-film interface 560. The refracted rays 513 strike the left facet of the prism and are reflected to the right facet of an adjacent prism. A portion of these rays strike the right facet and the rays 514 exit the film on-axis with the viewing angle. Another portion of the rays are reflected 515 toward the air-film interface 560. At the air-film interface 560, a portion of the rays 516 exit the film 550 and are recycled. Another portion of the rays 517 are reflected toward a prism, again striking a left prism facet. The reflected rays 517 reflect off the left facet and are again recycled resulting in a minimum gain valley of the Gain vs. S/p relationship.

FIG. 5D provides a ray history of a film 570 having prism pitch, p, but with a decreased thickness, Sₘ, and a higher index of refraction than the film 500 illustrated in FIGS. 5A-5B. Rays 518 enter the film 570 and are refracted at the air-film interface 510 with internal refraction angle, θ₂>θ₁ toward a prism. The refracted rays 519 strike the left facet of the prism and are reflected to the right facet of an adjacent prism. A portion of these rays strike the right facet and the rays 520 exit the film on-axis with the viewing angle. Another portion of the rays 521 are reflected toward the air-film interface 580. At the air-film interface 580, a portion of the rays 522 exit the film 570 and are recycled. Another portion of the rays 523 are reflected toward a prism. Although the refraction angle θ₂ of film 570 is greater than the refraction angle θ₁ in film 500, the decreased film thickness, Sₘ, results in similar ray history to that described in connection with FIG. 5B. The reflected rays 523 strike the right prism face and exit 527 the film 570 contributing to the on-axis gain and creating the peak gain values.

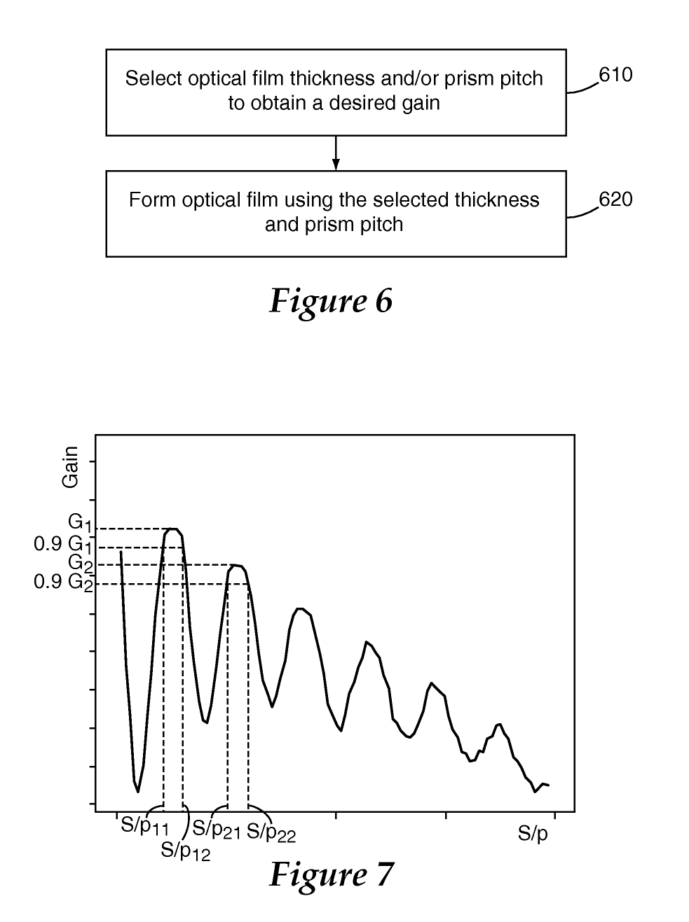

Embodiments of the invention are directed to forming optical films by methods that make use of the newly discovered relationship between gain and thickness to prism pitch ratio (S/p). The flow diagram of FIG. 6 illustrates a method for forming an optical film in accordance with embodiments of the invention. The method involves selecting 610, based on the relationship between gain and S/p ratio, one or both of the film thickness and the prism pitch to achieve a desired gain. The optical film is formed 620 using the selected thickness and/or prism pitch.

For example, the thickness and prism pitch of the film may be selected to provide an optimum gain or to provide a gain that falls within a range of the peak gain for any cycle of the gain to S/p relationship of the optical film. The graph of FIG. 7 illustrate S/p ratios that provide 90% of the peak gain for cycles m=1 or 2. As illustrated by FIG. 7, S/p ratios between S/p₁₁ and S/p₁₂ provide 90% of the peak gain for the m=1 cycle of the Gain vs. S/p relationship. S/p ratios between S/p₂₁ and S/p₂₂ provide 90% of the peak gain for the m=2 cycle of the Gain vs. S/p relationship. Once the S/p ratio to achieve a desired gain is determined from the graph, the film thickness and prism pitch may be selected as any appropriate or convenient values that maintain the ratio.

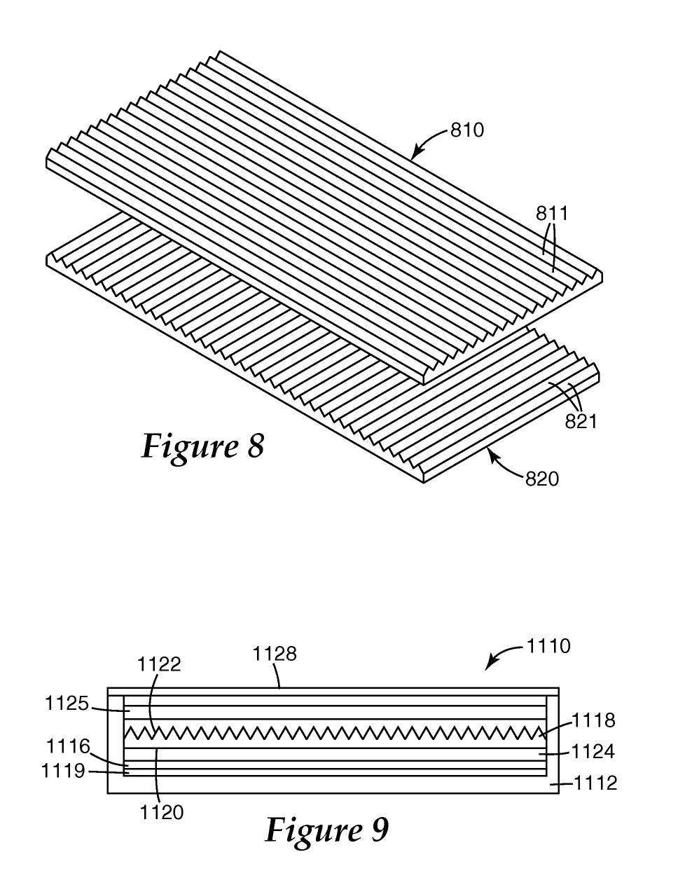

In some applications, the use of two or more optical films may be used to further enhance the properties of a display. As illustrated in FIG. 8, two optical films 810, 820, may be arranged with their prisms axes 812, 822 pointing in different directions in the film plane to increase the on-axis gain of the overall structure. For example, the films 810, 820 may be arranged so that their prism axes 812, 822 are substantially orthogonal or may be arranged so that the prism axis 811 of a first film 810 is at an angle of between about 45° and about 135° with the prism axis 812 of the second film 820. One or both of the optical films 810, 820 may have a thickness and prism pitch selected to achieve an S/p ratio that provides a desired gain in accordance with embodiments of the invention. In other embodiments, one of the films may be a structured brightness enhancement film as described herein, and the other film may be another type of film, such as a reflective polarizer.

Placement of a second sheet of optical film 810 closely adjacent to a first sheet 820 having prisms of equal height as illustrated in FIG. 8, may result in uneven light transmission across the surface area of a display under certain conditions. This uneven light transmission is typically manifested by visibly apparent bright spots, streaks, or lines on the surface of the display—a condition caused by optical coupling between contacting, or very nearly contacting, surfaces of the adjacent sheets of optical film. Such visibly apparent variations in the intensity of transmitted light across the surface area of the display are undesirable.

As described in commonly owned U.S. Pat. No. 5,771,328, which is incorporated herein by reference, variations in the intensity of transmitted light may be mitigated through the use of optical films having alternating zones of different heights. U.S. Pat. No. 5,771,328 describes optical films that may be used in an optical assembly such as the one illustrated in FIG. 8 along with an optical film having an S/p ratio selected to produce a desired gain in accordance with embodiments of the present invention. The optical films described in U.S. Pat. No. 5,771,328 include alternating relatively taller prism zones and relatively shorter prism zones, a configuration which mitigates the optical coupling between contacting, or very nearly contacting, surfaces of the adjacent sheets. Additional details regarding optical films having prisms that vary in height along one or both film axes are described in commonly owned U.S. Pat. Nos. 6,354,709, 6,581,286, 6,845,212, and 7142,767 which are incorporated herein by reference.

FIG. 9 illustrates a display panel incorporating one or more optical films in accordance with embodiments of the invention. Display 910 includes a case 912, an area source of light 916 and an optical film 918. A reflective material 919, for example, a diffuse reflector may be positioned behind area light source 916.

As previously described, the optical film of the present invention 918 has a flat surface 920 which faces the light source 1116 and a structured surface 922. Optical film 918 and area light source 916 may be separated by an optical diffuser 924.

The display 910 further includes a light gating device 926. Typically the light gating device 926 is a liquid crystal display, although other light gating devices, such as devices using electrochromic or electrophoretic materials may be used. As is well known in the art, a liquid crystal display may be made transparent or opaque, in the case of a monochrome display, or transparent or a variety of colors in the case of a color display by the proper application of electrical control signals. Application of the control signals causes a change in the orientation of the liquid crystals which forms images that will be visible when area light source 916 is illuminated. Display 910 further includes a transparent cover sheet 928.

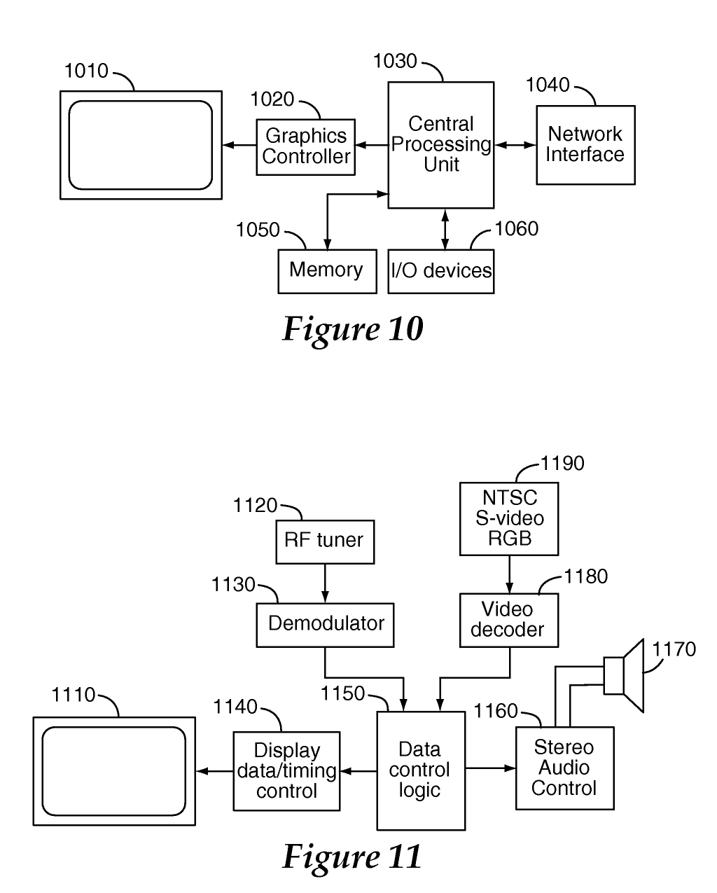

FIGS. 10-13 are block diagrams of exemplary devices incorporating displays in accordance with embodiments of the present invention. In addition to the exemplary devices described below, many other applications for displays incorporating optical films as described herein exist and will be readily apparent to the skilled practitioner. The systems illustrated in FIGS. 10-13 may be used, for example, with any configuration of brightness enhancement films described herein.

FIG. 10 shows basic components of a tablet, laptop, or desktop computer having a monitor that incorporates one or more optical films as described in the examples provided above. The computer includes a central processing unit 1030 coupled to an input device 1060 such as a keyboard, mouse, joystick or other pointing device. Memory storage 1050 may include RAM, ROM, disc drives or flash memory modules which can be used for program and/or data storage. A graphics controller 1020 controls an LCD or other type of display 1010 incorporating one or more optical films in accordance with embodiments of the present invention. Network connectivity for the computer may be provided through a wired or wireless network module 1040.

FIG. 11 illustrates another application for a display incorporating one or more of the optical films illustrated in various embodiments herein. A television may include RF and video input modules 1120, 1190. The RF tuner 1120 is coupled via a demodulator 1130 to television data and control logic 1150. Additionally, or alternatively, video input in formats such as NTSC, S-video, RGB and/or other video formats is decoded by video decoder 1180 and presented to the data/control logic 1150. Audio control circuitry 1160 is used to present audio information via speakers 1170. Video is presented on a display 1110 constructed in accordance with various embodiments described herein under control of a display data/timing module 1140.

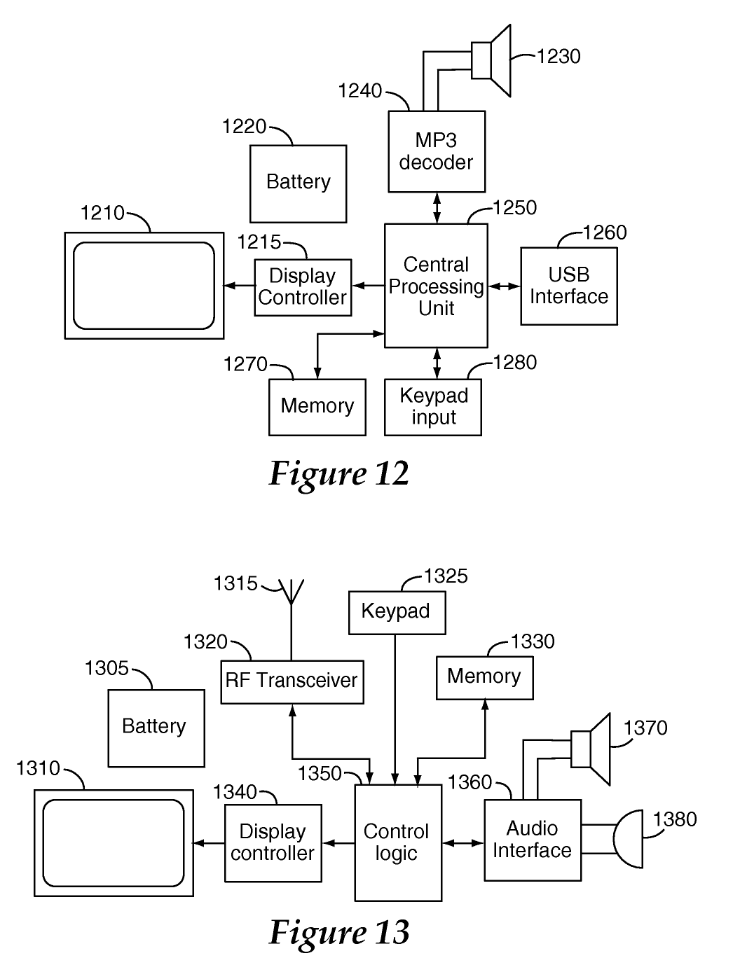

FIG. 12 is a block diagram of a handheld MP3 player that includes a display 1210 using one or more optical films fabricated in accordance with embodiments of the invention. The MP3 player is controlled by a central processing unit (CPU) 1250. Under control of the CPU 1250, data stored in MP3 format in memory 1270 is decoded via an MP3 decoder 1240. The MP3 decoder 1240 produces an output used to drive speakers or headphones 1230. The CPU 1250 presents graphics or text images on the display 1210 and receives input from a user via keypad 1280. The MP3 player may also include a USB, Bluetooth, or other wired or wireless interface 1260 to connect to a computer or other device. Power to the MP3 player is supplied by a battery 1220.

A cellular telephone incorporating a display in accordance with embodiments of the invention is illustrated in FIG. 13. The cellular telephone includes an RF transceiver 1320 coupled to an antenna 1315 configured to transmit and receive data and control signals to and from a base station operating in a cellular network. Data received via the transceiver 1320 is demodulated and converted to audio via the cell phone controller circuitry 1350. Voice data is presented to a user through an audio interface 1360 coupled to a speaker 1370. A microphone 1380 transduces voice to electrical signals which are then further processed by the transceiver 1320 prior to output via the antenna 1315. The cellular telephone includes a display 1310, e.g., an LCD display, having one or more optical films as described herein. Information is presented to a user on the display 1310 through an LCD controller 1340. The cellular telephone receives input from the user through a keypad 1325 and may also have memory 1330 for storing user information. The cellular telephone is powered by a rechargeable battery 1305.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method of fabricating an optical film having a non-prism portion with a thickness, S, and prisms arranged with a pitch, p, the optical film characterizable by a relationship between gain and thickness to prism pitch ratio (S/p) that varies cyclically,
selecting, based on the relationship between gain and S/p ratio, one or both of the thickness, S, and the prism pitch, p, of the optical film to obtain an S/p ratio that provides a desired gain; and
forming the optical film having the S/p ratio that provides the desired gain.

2. The method of claim 1, wherein selecting one or both of the thickness and prism pitch ratio comprises selecting to obtain an S/p ratio that provides a desired gain within a predetermined range of a peak gain for a cycle of the gain to S/p relationship of the optical film.

3. The method of claim 1, wherein the desired gain falls within a range of at least about 90% of a peak value of a gain of the optical film for a cycle of the gain to S/p relationship of the optical film.

4. The method of claim 1, wherein the cycle comprises a first cycle of the gain to S/p relationship of the optical film.

5. The method of claim 1, wherein the S/p ratio of the optical film provides an optimal gain in a direction substantially normal to the optical film.

6. The method of claim 1, wherein the S/p ratio of the optical film provides an optimal gain in a range of about +20° to about −20° from a direction normal to the optical film.

7. The method of claim 1, wherein forming the optical film comprises forming prisms having an included angle of about 90°.

8. The method of claim 1, wherein each prism has an included angle in a range of about 70° to about 120°.

9. The method of claim 1, wherein the trough or peak radius of the prisms is about 0.1 μm to about 10 μm.

10. The method of claim 1, wherein an index of refraction of the non-prism portion is about 1.5 to about 1.7.

11. The method of claim 1, further comprising disposing the optical film on an additional optical layer.

12. The method of claim 11, wherein the additional optical layer comprises a reflective polarizer.

13. The method of claim 11, wherein disposing the optical film on an additional optical layer comprises disposing a prism axis of the optical film at an angle with respect to a prism axis of the additional optical film.

14. The method of claim 13, wherein the angle is about 90°.

15. The method of claim 13, wherein the angle is between about 45° and about 135°.

16. An optical film characterizable by a relationship between gain and thickness to prism pitch ratio (S/p) that varies cyclically, the optical film comprising:
a non-prism portion having a thickness, S; and
prisms arranged with a prism pitch, p, an S/p ratio of the optical film within a range that provides at least about 90% of a peak gain for a cycle greater than 1 of the gain to S/p relationship of the optical film.

17. An optical film characterizable by a relationship between gain and thickness to prism pitch ratio (S/p) that varies cyclically, the optical film comprising:
a non-prism portion having an index of refraction less than 1.587, between 1.587 and 1.665 or greater than 1.665; and
prisms arranged on the substrate, an S/p ratio of the optical film within a range that provides at least about 90% of a peak gain for a cycle of the gain to S/p relationship of the optical film.

18. An optical film characterizable by a relationship between gain and thickness to prism pitch ratio (S/p) that varies cyclically, the optical film comprising:
a non-prism portion having a thickness, S; and
prisms arranged on the substrate with a trough or peak radius of the prisms greater than 1 μm, an S/p ratio of the optical film within a range that provides at least about 90% of a peak gain for a cycle of the gain to S/p relationship of the optical film.

19. An optical film characterizable by a relationship between gain and substrate thickness to prism pitch ratio (S/p) that varies cyclically, the optical film comprising:
a substrate; and
prisms arranged on the substrate, the prisms having an included angle other than 90°, an S/p ratio of the optical film within a range that provides at least about 90% of a peak gain for a cycle of the gain to S/p relationship of the optical film.

20. An optical film characterizable by a relationship between gain and thickness to prism pitch ratio (S/p) that varies cyclically, the optical film comprising:
a non-prism portion having a thickness, S; and
prisms arranged with a prism pitch, p, the S/p ratio of the optical film within a range that provides at least about 90% of a peak gain for a cycle of the S/p relationship of the optical film, excluding an optical film having a thickness of 2 mils (±1%), a prism pitch of 18 um (±1%), an included angle of 90° (±2 degrees), an index of refraction of 1.587 (±0.2%), and a trough width of 1 um (±0.2%) and an optical film having a thickness of 5 mils (±1%), a prism pitch of 50 um (±1%), an included angle of 90° (±2 degrees), a trough or peak radius of 1 um (±0.2%) and an index of refraction of 1.665 (±0.2%).

21. The optical film of claim 20, wherein the ratio provides the optimal gain through the film in a direction substantially normal to a plane of the optical film.

22. The optical film of claim 20, wherein the ratio provides the optimal gain through the film in a range of about +20° to about −20° from a direction normal to a plane of the optical film.

23. The optical film of claim 20, wherein the prisms comprise right regular prisms.

24. The optical film of claim 20, wherein each prism has an included angle in a range of about 70° to about 120°.

25. The optical film of claim 20, further comprising an additional layer.

26. The optical film of claim 25, wherein the additional layer comprises a polarizer film.

27. The optical film of claim 25, wherein the additional layer comprises an additional optical film, the additional optical film characterizable by the relationship between gain and thickness to prism pitch ratio (S/p) that varies cyclically, the additional optical film comprising:
a non-prism portion having a thickness, S; and
prisms arranged with a prism pitch, p, the S/p ratio of the additional optical film selected to provide a desired gain.

28. The optical film of claim 27, wherein a prism axis of the additional optical film is disposed at an angle with respect to a prism axis of the optical film.

29. The optical film of claim 28, wherein the angle between the prism axis of the additional optical film and the prism axis of the optical film is between 45° and 135°.

30. An optical assembly for displaying information, comprising:
a light source;
a display panel configured to display information; and
an optical film disposed between the light source and the display panel, the optical film characterizable by a relationship between gain and thickness to prism pitch ratio (S/p) that varies cyclically, the optical film comprising:
a non-prism portion having a thickness, S; and
prisms arranged with a prism pitch, p, the S/p ratio of the optical film within a range that provides at least about 90% of a peak gain for a cycle of the S/p relationship of the optical film, excluding an optical film having a thickness of 2 mils (±1%), a prism pitch of 18 um (±1%), an included angle of 90° (±2 degrees), an index of refraction of 1.587 (±0.2%), and a trough width of 1 um (±0.2%) and an optical film having a thickness of 5 mils (±1%), a prism pitch of 50 um (±1%), an included angle of 90° (±2 degrees), a trough or peak radius of 1 um (±0.2%) and an index of refraction of 1.665 (±0.2%).

31. A flat screen desktop computer monitor, comprising:
a light source;
a display panel configured to display information; and
an optical film disposed between the light source and the display panel, the optical film characterizable by a relationship between gain and thickness to prism pitch ratio (S/p) that varies cyclically, the optical film comprising:
a non-prism portion having a thickness, S; and
prisms arranged with a prism pitch, p, the S/p ratio of the optical film selected to provide at least about 90% of a peak gain for a cycle of the S/p relationship of the optical film.

32. A system, comprising:
a desktop computer; and
a flat screen computer monitor coupled to the computer, comprising:
a light source;
display panel configured to display information received from the desktop computer; and
an optical film disposed between the light source and the display panel, the optical film characterizable by a relationship between gain and thickness to prism pitch ratio (S/p) that varies cyclically, the optical film comprising:
a non-prism portion having a thickness, S; and
prisms arranged with a prism pitch, p, the S/p ratio of the optical film selected to provide at least about 90% of a peak gain for a cycle of the S/p relationship of the optical film.

33. A television, comprising:
a television receiver; and
a flat screen television monitor, comprising:
a light source;
a display panel configured to display information received from the television receiver; and
an optical film disposed between the light source and the display panel, the optical film characterizable by a relationship between gain and thickness to prism pitch ratio (S/p) that varies cyclically, the optical film comprising:
a non-prism portion having a thickness, S; and
prisms arranged with a prism pitch, p, the S/p ratio of the optical film selected to provide at least about 90% of a peak gain for a cycle of the S/p relationship of the optical film.
